(19) United States
(12) Patent Application Publication
(10) Pub. No.: US 2008/0227576 A1
(43) Pub. Date: Sep. 18, 2008

(54) Device for Power Transmission Between a Heat Engine Output and an Axle Shaft and Related Power Transmission Method

(75) Inventors: Sebastien Besnard, Bourg-la-Reine (FR); Olivier Boury, Nanterre (FR); Thomas Boutou, Paris (FR); Serge Belmont, Boulogne-Billancourt (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 11/909,422

(22) PCT Filed: Mar. 20, 2006
(86) PCT No.: PCT/FR2006/050241

§ 371 Date: Sep. 21, 2007

(30) Foreign Application Priority Data
Mar. 23, 2005 (FR) 0550752

(51) Int. Cl. B60K 6/20; F16H 3/72

(52) U.S. Cl. 475/5; 477/5

(57) ABSTRACT

The present invention concerns a device (1) for power transmission between an output (2) of a heat engine (3) and an axle (5) shaft (4) and a related power transmission method. Said device comprises an input shaft (10) connected to the output (2), an output shaft (14) connected to the axle shaft (4), first and second electrical machines (6, 7), and a mechanical assembly (12) assembling the input shaft (10), the output shaft (14) and the shafts (8, 9) of the two machines. In order to limit the dimension of the device, the assembly (12) consists of two planetary trains (65, 66) comprising common planet pinion cage (18) which drives axles (23-26) in contact with the planet pinion cage (18) and the planet pinions (19, 21) of said trains. Moreover, a first switching device (30) connects the shaft (8) of the first machine (6) either to the input shaft (10) or to an element (22) of one of the trains (65, 66) of the mechanical assembly (12).

The present invention concerns a device for power transmission between a heat engine output and a wheel shaft, and a related power transmission method. A particular purpose of the invention is to make such a device more compact. The invention has a particularly useful application in hybrid propulsion motor vehicles, but it could also be used in other types of hybrid propulsion land vehicles.

Transmission devices are known for hybrid vehicles that have a heat engine, two electrical machines and one, two or more planetary gear trains connected to one another within a mechanical assembly. An example of such a transmission device is described in the French patent application FR-A-2832357. With such transmission devices, the power from the heat engine can be transmitted directly to the wheels or split by sending it through an electrical system.

The electrical system connects the electrical machines, which are capable of functioning as a motor or as a generator, depending on levels of electrical and/or mechanical energies received at their terminals and on their shaft, respectively. The split power is retransmitted to the wheels of the vehicle or stored, if applicable, in a storage system. This split power makes it possible to accurately adjust the torque applied to the wheels of the vehicle to match the request of a driver, and at the same time accurately adjust the torque and speed of the heat engine as well, so as to optimize its performance.

In addition, the electrical system includes a first inverter, a second inverter and an electrical bus in particular. In practice, this electrical bus is a direct current bus.

When one of the machines is operating as a generator, the alternating current signals detectable between its phases are transformed by the inverter associated with this machine into a DC voltage signal detectable on the bus. When one of the electrical machines is operating as a motor, the DC voltage signal detectable on the bus is transformed into dephased AC voltage signals by the inverter associated with this machine. These voltage signals are applied to the phases of the machine that is operating as a motor.

In a case where no storage system is connected to the bus, the energy generated by one of the machines is automatically consumed by the other machine. As a variant, a storage system such as a battery or a supercondenser is connected to the bus. Both machines can then operate simultaneously as a generator or as a motor.

A device that is operable in two different operating modes is described in document FR-A-2832357. In a first mode, the shaft of one of the machines is connected to the wheel shaft, whereas in a second mode, this shaft is connected to an element of one of the planetary gear trains. The mode is selected according to the rotation speed of the wheel shaft and of the element of the gear train. That is, the machine shaft is connected perferentially to whichever element of the two is rotating at the lower speed (adjusted for the intermediate gear ratios). Since power split to the electrical system is equal to a rotation speed of a machine multiplied by a torque, changing from one mode to another makes it possible to reduce the power split to the electrical system. By reducing the power within the electrical system, it is possible to reduce the size of the electrical machines.

In addition, a mechanical assembly made up of planetary gear trains is described in this same document FR-A-2832357. These planetary gear trains each have three mechanical connecting elements and two degrees of freedom. A “connecting element” is defined as an element to which a shaft of the device is connectable; this shaft can be a driving shaft or a driven shaft. These planetary gear trains are connected to one another so as to form an assembly that has four mechanical connecting elements and two degrees of freedom. To this end, two connections are made between the two gear trains of the assembly, thus reducing the number of connecting elements from six to four and the number of degrees of freedom from four to two. More precisely, the sun gear of a first gear train is connected to a ring gear of a second gear train, and the planet carriers are connected to one another. However, these connections between the two gear trains make the transmission device cumbersome. That is, by connecting the sun gear to a ring gear, one connecting element of the mechanical assembly loses its mobility.

The invention thus proposes to solve these problems relating to the overall size of the transmission device by simultaneously reducing the size of the electrical machines and the size of the transmission device.

To further reduce the overall size of the electrical machines, the invention proposes the use of new operating modes. To this end, the shaft of one of the machines of the device is connectable either to the shaft of the heat engine or to an element of one of the planetary gear trains. This way, in a first operating mode, the shaft of one of the machines is connected to one of the elements of one of the gear trains, while the shaft of the other machine is connected to the wheel shaft. In a second operating mode, the shafts of both machines are each connected to an element of one of the planetary gear trains. And in a third operating mode, the shaft of one of the machines is connected to the engine shaft, while the shaft of the other machine is connected to an element of one of the planetary gear trains. The shafts of both machines are thus connected to the element that reduces their rotation speeds, thereby reducing the power diverted to the electrical system.

In addition, in order to reduce the size of the mechanical assembly, the two gear trains are connected in a way that dispenses with one connecting element. That is, the two gear trains are connected so that their planet gears are carried by a shared planet carrier and these planet gears are intermeshing. The fact that the planet gears are carried by a shared planet carrier makes it possible to dispense with a connection between two planet carriers, for example. The fact that the planet gears intermesh makes it possible to eliminate one degree of freedom in the assembly without losing a connecting element, since no shaft can be connected to the planet gears. Two gear trains connected in this manner have five mechanical connecting elements. It is thus possible to eliminate one connecting element of the assembly in order to obtain the four connecting elements with two degrees of freedom needed for the system to operate as it should. Of course, eliminating one element reduces the overall size of the mechanical assembly. Generally, the ring gear of one of the gear trains is eliminated. As a variant, instead of intermeshing, the planet gears are coaxial and are attached two to one pin.

The invention thus concerns a device for power transmission between a heat engine output and a wheel shaft, including:
an input shaft connected to the output of the heat engine, and an output shaft connected to the wheel shaft,
a first and a second electrical machine, each of which has a shaft and
a mechanical assembly connecting the input shaft, the output shaft and the shafts of the machines to one another, this mechanical assembly being made up of at least two planetary gear trains, these two planetary gear trains each having several intermeshing elements, including a sun gear, planet gears connected to a planet carrier, and a ring gear, characterized in that:
the two planetary gear trains share a common planet carrier that drives pins in contact with the shared planet carrier and the planet gears, and in that it has
a first switching device having means to connect the shaft of the first machine either to the input shaft or to an element of one of the gear trains.

The invention also concerns a power transmission method in which:
a power transmission device is employed to transmit power between a heat engine output and a wheel shaft, this device having an input shaft connected to the output of the heat engine, an output shaft connected to the wheel shaft, two electrical machines, each of which has a shaft,

characterized in that:
the input shaft, the output shaft and the shafts of the two machines are connected to a mechanical assembly made up of at least two planetary gear trains, these two gear trains having a shared planet carrier that drives pins in contact with the shared planet carrier and with planet gears of these gear trains, and in that:
in a first operating mode, the shaft of the first machine is connected to a first element of one of the planetary gear trains, and the shaft of the second machine is connected to the wheel shaft,
in a second operating mode, the shaft of the first machine is connected to the first element and the shaft of the second machine is connected to a second element of one of the planetary gear trains,
in a third operating mode, the shaft of the first machine is connected to the input shaft, and the shaft of the second machine is connected to the second element.

The following description and accompanying figures will make the invention more easily understood. These figures are given as an illustration, and are in no way an exhaustive representation of the invention. These figures show:

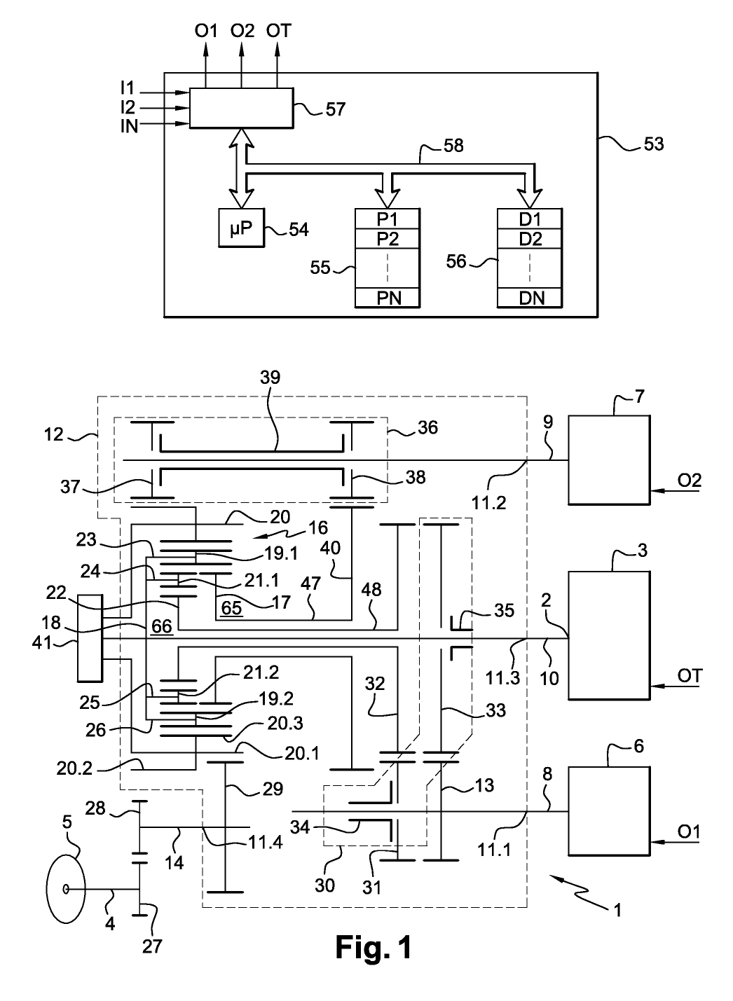

FIG. 1: A schematic representation of a transmission device according to the invention;

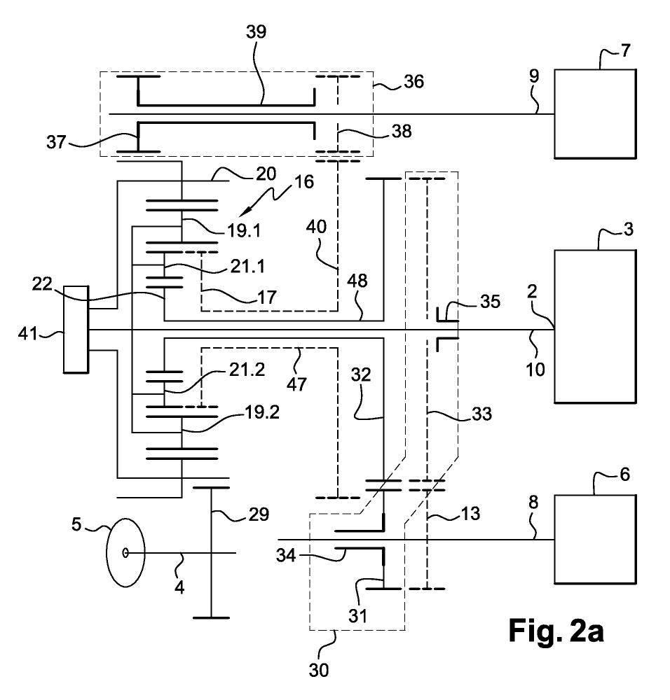

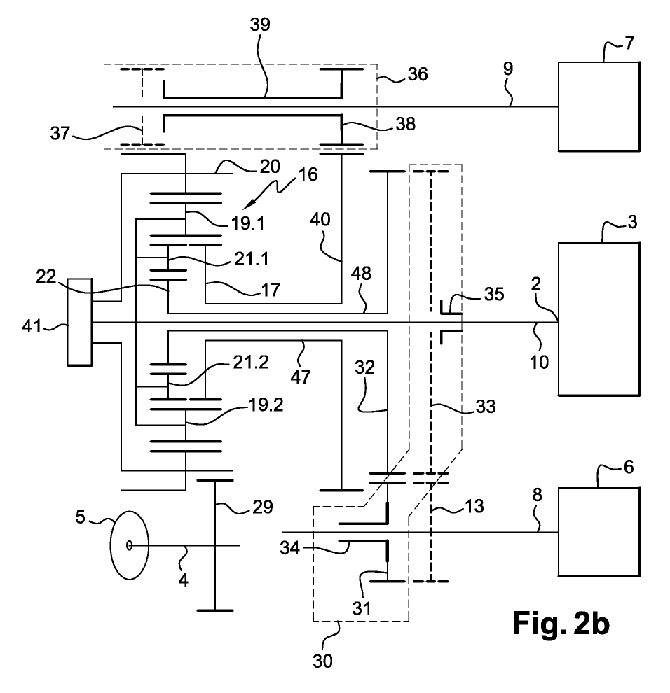

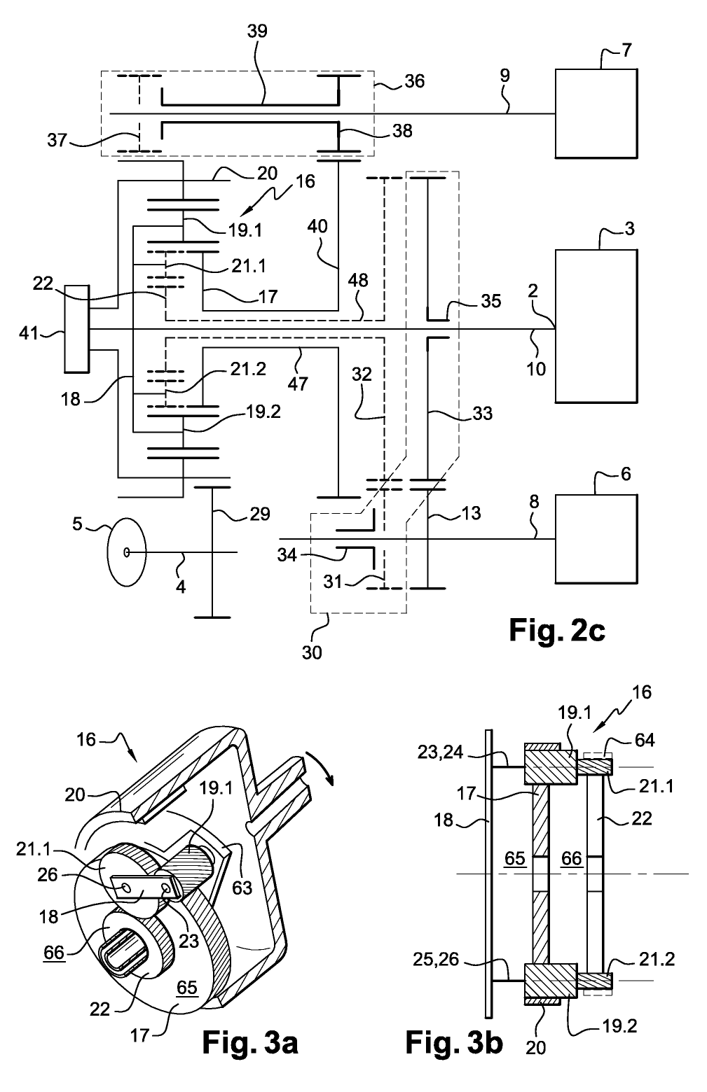

FIG. 2a: An implementation of the transmission device according to the invention in a first operating mode;

FIG. 2b: An implementation of a transmission device according to the invention in a second operating mode;

FIG. 2c: An implementation of the transmission device according to the invention in a third operating mode;

FIG. 3a: A partial section perspective view of a mechanical assembly according to the invention;

FIG. 3b: A side view of the mechanical assembly according to the invention.

On these figures, the same element is always labeled with the same number.

FIG. 1 shows a schematic representation of a transmission device 1 according to the invention between an output 2 of a heat engine 3 and a shaft 4 of wheels 5.

This device 1 has a first electrical machine 6 and a second electrical machine 7. These machines 6 and 7 have a shaft 8 and a shaft 9, respectively. These shafts 8 and 9 are connected to drive inputs 11.1 and 11.2, respectively, of a mechanical assembly 12. This device 1 also has an input shaft 10 connected to the output 2 of the heat engine 3 and to a drive input 11.3 of the mechanical assembly 12. This device 1 also has an output shaft 14 connected simultaneously to the shaft 4 of wheels 5 and to a drive output 11.4 of the mechanical assembly 12. For greater simplicity, the electrical system connecting the electrical machines 6 and 7 to one another is not shown.

More precisely, the mechanical assembly 12 has a so-called Ravigneaux-type gear train 16. This gear train 16 has four mechanical connecting elements: one for the input shaft 10, another for the output shaft 14, and the two others for the shafts 8 and 9 of the machines 6 and 7. Like a conventional planetary gear train, this gear train 16 has a first sun gear 17, a planet carrier 18 carrying a first set of planets 19.1 and 19.2, and a ring gear 20 that intermesh. In addition, the gear train 16 has a second set of planets 21.1 and 21.2, and a second sun gear 22. The second set of planet gears 21.1 and 21.2 is carried by the planet carrier 18, and meshes simultaneously with the first set of planet gears 19.1 and 19.2 and with the sun gear 22.

The Ravigneaux gear train 16 can thus be compared to two planetary gear trains 65 and 66. The first gear train 65 includes the first sun gear 17, the planet gears 19.1 and 19.2, and the ring gear 20. The second gear train 66 includes the second sun gear 22 and the second planet gears 21.1 and 21.2, but it lacks a ring gear. These two gear trains 65 and 66 share the common planet carrier 18. This planet carrier 18 drives pins 23-26 in simultaneous contact with this planet carrier 18 and planet gears 19.1, 19.2, 21.1 and 21.2. The planet gears 19.1, 19.2, 21.1 and 21.2 are rotatable on the pins 23, 24, 25 and 26, respectively. As a variant, the planet gears 19.1 and 21.1 and the planet gears 19.2 and 21.2 can be integral and coaxial with one another, as will be shown.

In this embodiment, the input shaft 10 is connected simultaneously to the output 2 of the heat engine 3 and to the shared planet carrier 18. The shaft 4 of wheels 5 is connected to the ring gear 20 via a gear assembly made up of the gear wheels 27 and 28, the output shaft 14, and a gear wheel 29. More precisely, the gear wheel 27 attached to the shaft 4 meshes with the gear wheel 28 attached to one end of the output shaft 14. And the gear wheel 29 attached to another end of the shaft 14 meshes with the ring gear 20.

This ring gear 20 bears two sets of outer teeth 20.1 and 20.2 and a set of inner teeth 20.3 for this purpose. The gear wheel 29 meshes with the outer teeth 20.1. The first planet gears 19.1 and 19.2 mesh with the inner teeth 20.3. And a pinion 37 meshes with the outer teeth 20.2, as will be seen below.

The shaft 8 of the first machine 6 is connectable either to the second sun gear 22 or to the input shaft 10. For this purpose, the transmission device 1 has a first switching device 30 shown enclosed within a dashed line. This first device 30 has the pinions 31 and 33 and two separate dog clutches 34, 35. The pinion 31 and the first dog clutch 34 are mounted on the shaft 8, whereas the pinion 33 and the second dog clutch 35 are mounted on the shaft 10.

Thus, when the shaft 8 is connected to the second sun gear 22, the first dog clutch 34 makes a connection between the pinion 31 and the shaft 8, while the pinion 33 spins freely on the shaft 10. The shaft 8 is then connected to the second sun gear 22 via a gear assembly made up of the pinion 31 and the gear wheel 32, and a hollow shaft 48 connecting the gear wheel 32 to the sun gear 22. When the shaft 8 is connected to the input shaft 10, the second dog clutch 35 makes a connection between the pinion 33 and the shaft 10, while the pinion 31 spins freely on the shaft 8. The shaft 8 is thus connected to the shaft 10 via a gear assembly made up of the gear wheel 13 and the pinion 33.

The shaft 9 of the second machine 7 is connectable either to the shaft 4 of wheels 5 or to the first sun gear 17. For this purpose, the device 1 has a second switching device 36. This second device 36 has pinions 37, 38, and a third, one-piece dog clutch 39.

When the shaft 9 is connected to the shaft 4 of wheels 5, the third dog clutch 39 makes a connection between the pinion 37 and the shaft 9, while the pinion 38 spins freely on the shaft 9. The shaft 9 is then connected to the shaft 4, in particular via the pinion 37, the ring gear 20 and the output shaft 14. When the shaft 9 is connected to the first sun gear 17, the dog clutch 39 makes a connection between the pinion 38 and the shaft 9, while the pinion 37 spins freely on the shaft 9. The shaft 9 is then connected to the first sun gear 17 via a gear assembly made up of the pinion 38 and the gear wheel 40, and a hollow shaft 47 connecting the gear wheel 40 to the sun gear 17.

As a variant, the first device 30 has a one-piece dog clutch and is mounted solely on the shaft 8. As a variant, the second device 36 has two separate dog clutches mounted on the shaft 9.

The dog clutches 34, 35 and 39 are rotationally driven by the shaft on which they are mounted, and are capable of moving translationally along this shaft. The dog clutches are usually moved translationally via forks driven by a direct current motor.

In a particular embodiment, the shared planet carrier 18 and the ring gear 20 are connected to an oil pump 41 via a free-wheel mechanism (not shown).

As a variant, the shafts 8 and 9, the input shaft 10 and the output shaft 14 are connected to different elements of the gear train 16.

FIGS. 2a-2c illustrate the operation of the transmission device in different modes. For greater simplicity, the shaft 4 of wheels 5 and the output shaft 14 are considered to be combined in these figures. FIG. 2a illustrates the first operating mode of the device 1 according to the invention.

In this first operating mode, the shaft 8 of the machine 6 is connected to the second sun gear 22. And the shaft 9 of the second machine 7 is connected to the shaft 4 of wheels 5. Consequently, the first dog clutch 34 is engaged inside the pinion 31, while the second dog clutch 35 is disengaged from the pinion 33. In addition, the dog clutch 39 is engaged inside the pinion 37, but disengaged from the pinion 38.

The gear wheel 13 and the pinion 33 spinning freely on the shaft 10 are shown with a dashed line because they are not transmitting power to the shaft 4 of wheels 5. In addition, the first sun gear 17 and the gear wheel 40, which are connected to one another via the hollow shaft 47, are also shown as a dashed line, because they are not transmitting power to the shaft 4 of wheels 5, either.

Thus, in this first mode, the machine 6 can exchange power with the shaft 4 of wheels 5 via the pinion 31, the gear wheel 32, the shaft 48, the second sun gear 22, the second set of planet gears 21.1 and 21.2, the first set of planet gears 19.1 and 19.2, and the ring gear 20. The machine 7 can exchange power with the shaft 4 of wheels 5 via the ring gear 20 and the gear wheel 29.

The first operating mode is employed for low gear ratios. In one example, these gear ratios correspond to a vehicle speed between 0 and 15 km/h, when the speed of the heat engine 3 is 1000 rpm. This first mode is generally used when setting the vehicle in motion, but it can also be used for reverse gears of the vehicle.

As soon as the rotation speed of the pinion 37 driven by the wheel shaft 4 is greater than the rotation speed of the pinion 38 driven by the first sun gear 17, the transmission device 1 shifts to the second operating mode.

FIG. 2b illustrates this second operating mode.

In this second mode, the shaft 8 of the first machine 6 is connected as previously to the second sun gear 22. And the shaft 9 of the second machine 7 is connected to the first sun gear 17. Consequently, the dog clutch 34 is still engaged in the pinion 31, while the dog clutch 35 is still disengaged from the pinion 33. The dog clutch 39 is engaged in the pinion 38, but is disengaged from the pinion 37.

The gear wheel 13 and the pinion 33 spinning freely on the shaft 10 are shown as a dashed line, because, as previously, they are not transmitting power to the shaft 4 of wheels 5. The pinion 37 spinning freely on the shaft 9 is also represented as a dashed line, because it is no longer transmitting power to the shaft 4 of wheels 5.

In this second mode, then, the machine 6 can exchange power with the shaft 4 of wheels 5 via the pinion 31, the gear wheel 32, the shaft 48, the second sun gear 22, the second set of planet gears 21.1 and 21.2, the first set of planet gears 19.1 and 19.2, and the ring gear 20. The machine 7 can exchange power with the shaft 4 of wheels 5 via the pinion 38, the gear wheel 40, the shaft 47, the first sun gear 17, the first set of planet gears 19.1 and 19.2, and the ring gear 20.

This second operating mode is employed for gear ratios higher than those of the first mode, but lower than those of a third mode. The gear ratios of the second mode correspond for example to vehicle speeds between 15 and 50 km/hour, for a heat engine speed of 1000 rpm. This second mode is generally used after the vehicle has been set in motion, when it is in forward drive.

As soon as the rotation speed of the pinion 31 driven by the second sun gear 22 is greater than that of the input shaft 10 (adjusted for a gear ratio), the transmission device 1 shifts to the third operating mode.

FIG. 2c illustrates this third operating mode.

In this third mode, the shaft 8 of the first machine 6 is connected to the input shaft 10. And the shaft 9 of the second machine 7 is connected to the first sun gear 17. Consequently, the dog clutch 34 is disengaged from the pinion 31, and the dog clutch 35 is engaged in the pinion 33. The dog clutch 39 is still engaged in the pinion 38 and disengaged from the pinion 37.

The pinion 31 spinning freely on the shaft 8, the gear wheel 32, the shaft 48, the second sun gear 22 and the second set of planet gears 21.1 and 21.2 are represented by dashed lines, because they are not transmitting power to the shaft 4 of wheels 5. The pinion 37 spinning freely on the shaft 9 is not transmitting power either, and is therefore also represented by a dashed line.

In this third mode, then, the first machine 6 can exchange power with the shaft 4 of wheels 5 via the gear wheel 13, the pinion 33, the shaft 10, the planet carrier 18 and the ring gear 20. The second machine 7 can exchange power with the shaft 4 of wheels 5 via the pinion 38, the gear wheel 40, the shaft 47, the first sun gear 17, the first set of planet gears 19.1 and 19.2 and the ring gear 20.

This third operating mode is employed for higher transmission ratios than those of the second mode. The gear ratios of the third mode correspond for example to vehicle speeds greater than 50 km/hour.

Of course, the device can also shift from the third mode to the second mode and from the second mode to the first mode when conditions are the reverse of those described above.

In the three operating modes, when the vehicle is in a drive phase (with the motor supplying power to the wheels) or a recharge phase (with the wheels driving the motor), the first machine 6 acts as a generator while the second machine 7 acts as a motor (or the reverse). Furthermore, in a case where a battery is connected to the electrical bus (not shown) that connects the machines 6 and 7, then these two machines 6 and 7 are capable of operating simultaneously as a motor or as a generator.

In practice, the switch from the first mode to the second mode or the reverse occurs when the rotation speed of the shaft 4 of wheels 5 equals the rotation speed of the first sun gear 17, adjusted for a gear ratio. And the switch from the second mode to the third mode or the reverse occurs when the rotation speed of the input shaft 10 equals the rotation speed of the first element 22, adjusted for a gear ratio.

Furthermore, in order to switch smoothly from the first to the second operating mode and back, a basic transmission ratio is selected for the Ravigneaux-type gear train 16, or more accurately for the two gear trains 65 and 66, such that when the rotation speed of the shaft 9 equals the rotation speeds of the pinions 37 and 38 and of the dog clutch 39, then the rotation speed of the shaft 8 of the first machine 6 is zero. Then the power in the electrical system is zero and the torque applied to the shaft 9 is zero. The dog clutch 39 can then easily decouple from the pinion 37 to couple with the pinion 38, or the reverse.

Likewise, in order to switch smoothly from the second to the third operating mode and back, the basic transmission ratios selected for the gear trains 65 and 66 are such that when the rotation speed of the shaft 8 equals the rotation speeds of the pinions 31 and 33 and of the dog clutches 34 and 35, then the rotation speed of the shaft 9 is zero. Then the power in the electrical system is zero and the torque applied to the shaft 8 is zero. The dog clutch 35 can then easily engage in the pinion 33 and the dog clutch 34 can easily disengage from the pinion 31, or the reverse.

In a particular embodiment of the invention, the dog clutches 33, 34 and 39 ensure an unbroken transition from one mode to another. That is, the geometry of the dog clutch 39 is such that when it decouples from the pinion 37 to couple with the pinion 38 or the reverse, it simultaneously connects these pinions 37 and 38 to the shaft 9. The length of the one-piece dog clutch 39 is thus generally greater than an axial distance between the two pinions 37 and 38. Likewise, the dog clutches 34 and 35 are controlled independently, so that when they decouple from the pinion 31 to couple with the pinion 33 or the reverse, they simultaneously connect these pinions 31 and 33 to the shaft 8 and the shaft 10.

The mode is selected in such a way that for a given engine power, the heat engine 3 always runs at its optimal operating point, that is, at the point where its fuel consumption is the lowest. To this end, the transmission device 1 has a control unit 53 (see FIG. 1), such as a microcontroller, that controls this heat engine 3, the electrical machines 6 and 7, and the switching devices 30 and 36.

This control unit 53 has a microprocessor 54, a program memory 55 with programs P1-PN, a data store 56 with data D1-DN and an input-output interface 57, connected to one another via a bus 58.

Input signals I1-IN sent to the interface 57 correspond to a setpoint torque to apply to the wheel shaft 4, for example, or to measurements picked up by force, speed, acceleration, or other sensors (not shown). Data D1-DN correspond in particular to charts of immediate fuel consumption by the heat engine 3 and performance charts for the electrical machines 6 and 7. According to these data D1-DN and the input signals I1-IN, the microprocessor 54 executes one of the programs P1-PN that generates output signals O1, O2 and OT. These output signals O1, O2 and OT command the first machine 6, the second machine 7 and the heat engine 3 so as to make these members 3, 6 and 7 run at their operating point that corresponds to the lowest immediate fuel consumption by the heat engine 3. If the unit 53 calculates that the lowest fuel consumption corresponds to a low gear ratio, then the first operating mode will be employed. Conversely, if the unit 53 calculates that the lowest fuel consumption corresponds to a higher gear ratio, then the second or the third mode will be employed, according to the circumstances.

FIG. 3a shows a partial section three-dimensional view of a Ravigneaux-type gear train 16. For greater simplicity, the outer teeth of the ring gear 20 are not shown.

This figure shows that the gear train 16 is made up of a first gear train 65 having a first sun gear 17, a first set of planet gears 19.1 and a ring gear 20, and a second gear train 66 having a second sun gear 22 and a second set of planet gears 21.1. This second gear train 66 is lacking a ring gear.

The planet gears 19.1 and 21.1 of the two gear trains 65 and 66 are connected to the shared planet carrier 18 and mesh with one another. More precisely, the pin 23 of the first planet gear 19.1 is in contact with this first planet gear 19.1 and the shared planet carrier 18. The pin 26 of the second planet gear 21.1 is in contact with this second planet gear 21.1 and the shared planet carrier 18. The planet carrier 18 rotationally drives the pins 23 and 26. The planet gear 19.1 is rotatable on the pin 23. The planet gear 21.1 is rotatable on the pin 26, in a direction opposite to the planet gear 19.1.

In a particular embodiment, the Ravigneaux gear train 16 further has a circular flange 63 to which the pins 23 of the first planet gears 19.1 are connected.

The gear train 16 generally has a first set of three planet gears 19.1 and a second set of three planet gears 21.1.

FIG. 3b shows an alternative embodiment of the gear train 16. In this variant, the first gear train 65 still has the sun gear 17, the first set of planet gears 19.1 and 19.2 and the ring gear 20, which mesh with one another. The second gear train 66 still has the sun gear 22 and the second set of planet gears 21.1 and 21.2, which mesh with one another.

In this variant, the planet gears 19.1, 19.2, 21.1 and 21.2 are still carried by the shared planet carrier 18. However, here, the second set of planet gears 21.1 and 21.2 is attached to and integral with the first set of planet gears 19.1 and 19.2. Also, the first and second sets of planet gears are coaxial.

The pins 23 and 24 of the planet gears 19.1 and 21.1 are combined here, and are connected simultaneously to the shared planet carrier 18 and the planet gear 19.1. The planet gears 19.1 and 21.1 are rotatable on the pins 23 and 24.

Likewise, the pins 25 and 26 of the planet gears 19.2 and 21.2 are combined in this way, and are also connected simultaneously to the shared planet carrier 18 and the planet gear 19.2. The planet gears 19.2 and 21.2 are rotatable on the pins 25 and 26.

As a variant, in order to have an additional connecting element, it is possible to retain a second ring gear 64 (that of the second gear train 66) in mesh with the sun gears 21.1, 21.2. This second ring gear 64 could thus make it possible to connect a third electrical machine within the transmission device 1. As a variant, the gear train 16 is made up of more than two planetary gear trains.

1. Device for power transmission between an output of a heat engine and a shaft of wheels comprising:
an input shaft connected to the output of the heat engine (3), and an output shaft connected to the shaft of wheels,
a first and a second electrical machine, each having a shaft, and
a mechanical assembly connecting the input shaft, the output shaft and the shafts of the machines to one another, this mechanical assembly being made up of at least two planetary gear trains, these two planetary gear trains each having several intermeshing elements, including a sun gear, planet gears connected to a planet carrier, and a ring,
gear, the two planetary gear trains sharing a common planet carrier that drives pins in contact with the shared planet carrier and planet gears, and
a first switching device having means to connect the shaft of the first machine either to the input shaft or to an element of one of the gear trains, the connection between the shaft of the first machine and the input shaft not being made via an element of one of the planetary gear trains.

2. Device according to claim 1, wherein:
the planet gears of the different gear trains mesh with one another.

3. Device according to claim 1 wherein:
the mechanical assembly is made up of a first and a second planetary gear train, the second gear train having no ring gear.

4. Device according to claim 3, wherein:
the input shaft is connected to the shared planet carrier, and
the first switching device has means to connect the shaft of the first machine either to the input shaft or to an element of the second gear train.

5. Device according to claim 4, wherein:
the basic transmission ratios for the gear trains are selected so that when the rotation speed of the shaft of the first machined equals the rotation speeds of the connection means of the first switching device, then the rotation speed of the shaft of the second machine is zero.

6. Device according to claim 3, comprising a second switching device having means for connecting the shaft of the second machine either to the ring gear of the first gear train or to a sun gear of the first gear train, the ring gear being connected to the shaft of wheels.

7. Device according to claim 6, wherein:
the basic transmission ratios for the gear trains are selected so that when the rotation speed of the shaft of the second machine equals the rotation speeds of the connection means of the second switching device, then the rotation speed of the shaft of the first machine is zero.

8. Device according to claim 1, wherein:
the first switching device has a first and a second dog clutch that are distinct, the first dog clutch being connected to the shaft of the first machine, the second dog clutch being connected to the input shaft.

9. Device according to claim 1, comprising:
a control unit, this control unit having means to command the electrical machines and the heat engine in such a way that the engine always runs at the operating point where its fuel consumption is the lowest.

10. Power transmission method in which:
a power transmission device is employed to transmit power between an output of a heat engine and a shaft of wheels, this device having an input shaft connected to the output of the heat engine, an output shaft connected to the shaft of wheels, two electrical machines, each of which has a shaft, and
the input shaft, the output shaft and the shafts of the two machines are connected to a mechanical assembly made up of at least two planetary gear trains, these two gear trains having a shared planet carrier that drives pins in contact with the shared planet carrier and with planet gears of these gear trains, wherein:
in a first operating mode, the shaft of the first machine is connected to a first element of one of the planetary gear trains, and the shaft of the second machine is connected to the shaft of wheels,
in a second operating mode, the shaft of the first machine is connected to the first element and the shaft of the second machine to a second element of one of the planetary gear trains, and
in a third operating mode, the shaft of the first machine is connected to the input shaft, and the shaft of the second machine is connected to the second element.

11. Method according to claim 10, wherein:
a shift from the first to the second operating mode or the reverse takes place when the rotation speed of the shaft of wheels equals the rotation speed of the second element, adjusted for a gear ratio.

12. Method according to claim 11, wherein:
the rotation speed of the shaft of the first machine is canceled.

13. Method according to claim 10, wherein:
a shift from the second to the third operating mode or the reverse takes place when the rotation speed of the input shaft equals the rotation speed of the first element, adjusted for a gear ratio.

14. Method according to claim 13, wherein:
the rotation speed of the shafts of the second machined is canceled.
